(19) United States
(12) Patent Application Publication
(10) Pub. No.: US 2004/0206005 A1
(43) Pub. Date: Oct. 21, 2004

(54) Shutter mounting adjuster

(76) Inventor: Lawrence Chen, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/414,248

(22) Filed: Apr. 16, 2003

(51) Int. Cl. E06B 3/34

(52) U.S. Cl. 49/381

(57) ABSTRACT

A shutter mounting adjuster provided between one vertical peripheral wall of an opening for shutter and a hanging strip of a shutter to support the shutter in vertical is disclosed to include a slider movably mounted in a longitudinal sliding groove of the hanging strip of the shutter, and an arched spring strip fixedly mounted on the slider for movement with the slider along the longitudinal sliding groove. The arched spring strip has an arched body portion fixedly fastened to the slider and two bearing tips respectively extended from two distal ends of the arched body portion in reversed directions and respectively pressed on the vertical peripheral wall.

### BACKGROUND OF THE INVENTION

1. Field of the Invention

The present invention relates to shutter mounting techniques and, more specifically, to a shutter mounting adjuster, which enables the shutter to be quickly installed in a window of a building and easily adjusted to the accurate position during installation.

2. Description of the Related Art

When constructing a building, openings are left in the outer wall of the building for mounting shutters. However, the openings may not perfectly fit the size of the shutters to be installed. When a shutter set in vertical in one opening in the outer wall of a building, a gap may be left between the hanging strip of the shutter and one vertical peripheral wall of the opening. In this case, the gap must be sealed with filler means. FIG. 1 shows the installation of a shutter according to a conventional method. As illustrated, a gap 5 is left between one vertical peripheral wall 3 of the opening of the building and the hanging strip 2 of the shutter 1 after the shutter 1 has been set in vertical in the opening of the building, and foamed filler materials 4 are stuffed in between the vertical peripheral wall 3 and the hanging strip 2 of the shutter 1 to seal the gap 5. This shutter mounting method has numerous drawbacks as outlined hereinafter.

1. It is complicated to seal the gap 5 with foamed filler materials 4. The worker may have to adjust the stuffing of the foamed filler materials 4 several times before the hanging strip 2 of the shutter 1 accurately adjusted to vertical position.

2. The foamed filler materials 4 will become aged soon after installation of the shutter 1. When the foamed filler materials 4 aged, they cannot support the shutter 1 firmly in position, and the shutter 1 tends to be biased after the foamed filler materials 4 aged.

3. The foamed filler materials 4 tend to project out of the gap 5, destroying the sense of beauty of the outer appearance of the building.

### SUMMARY OF THE INVENTION

The present invention has been accomplished under the circumstances in view. It is the primary object of the present invention to provide a shutter mounting adjuster, which improves shutter mounting efficiency.

It is another object of the present invention to provide a shutter mounting adjuster, which prolongs the service life of the shutter.

It is still another object of the present invention to provide a shutter mounting adjuster, which decorates the shutter, causing a sense of beauty.

To achieve these objects of the present invention, the shutter mounting adjuster is provided between one vertical peripheral wall of an opening for shutter and a hanging strip, which has a longitudinal sliding groove, of a shutter to support the shutter in vertical, comprising a slider mounted in the longitudinal sliding groove of the hanging strip of the shutter and movable along the longitudinal sliding grove, and a spring member fixedly mounted on the slider for movement with the slider along the longitudinal sliding groove of the hanging strip of the shutter. The spring member has a portion thereof pressed on the vertical peripheral wall.

### BRIEF DESCRIPTION OF THE DRAWINGS

FIG. 1 is a schematic drawing showing a shutter installed in a wall opening according to the prior art.

FIG. 2 is a schematic installed view of a first preferred embodiment of the present invention.

FIG. 3 is a schematic installed view of a second preferred embodiment of the present invention.

FIG. 4 is a perspective view of a third preferred embodiment of the present invention.

FIG. 5 is a sectional view taken along line 5-5 of FIG. 4.

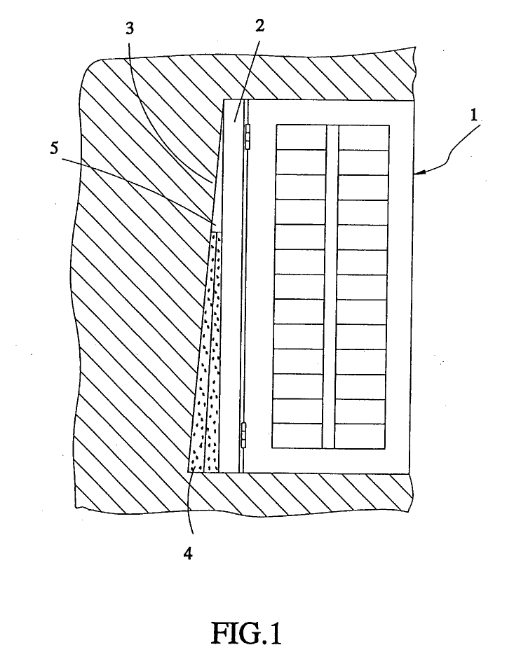

### DETAILED DESCRIPTION OF THE INVENTION

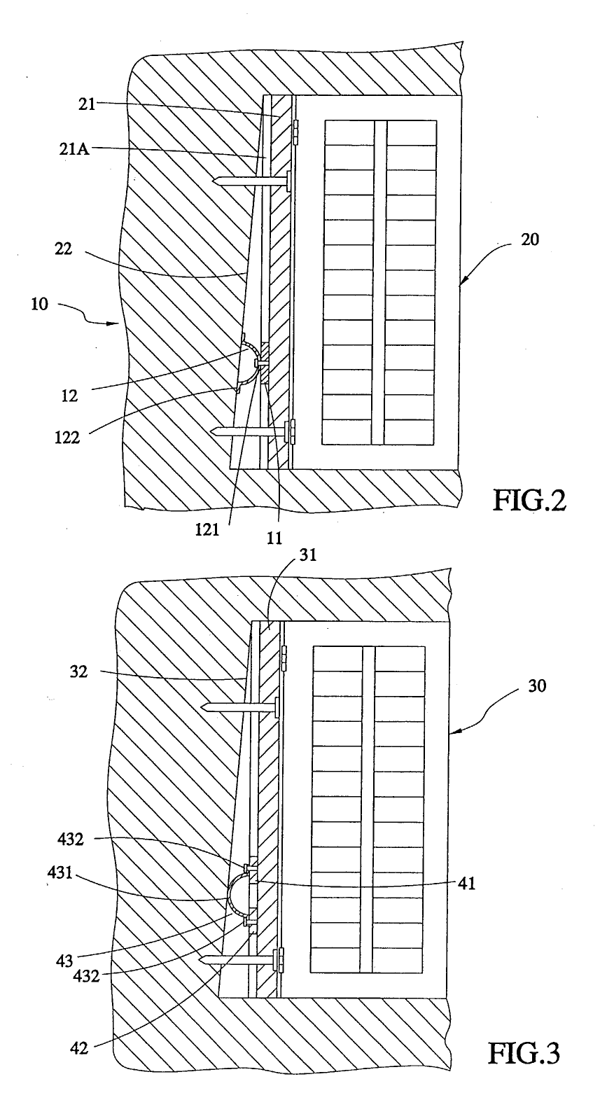

As shown in FIG. 2, a shutter mounting adjuster 10 is provided between one vertical peripheral wall 22 of an opening for shutter and the hanging strip 21 of a shutter 20. The hanging strip 21 has a longitudinal sliding groove 21A longitudinally extended through the top and bottom ends of one side thereof and facing the wall 22. The shutter mounting adjuster 10 comprises a slider 11 movably mounted in the longitudinal sliding groove 21A of the hanging strip 21, and an arched spring strip 12 fixedly mounted on the slider 11. The arched spring strip 12 has an arched body portion 121 fixedly fastened to the slider 11, and two bearing tips 122 respectively extended from the two distal ends of the arched body portion 121 in reversed directions for pressing on the wall 22.

During installation of the shutter 20, the shutter 20 is set in the opening for shutter in vertical, keeping the two bearing tips 122 of the arched spring strip 12 pressed on the wall 22, and then the slider 11 is moved by force along the longitudinal sliding groove 21A to a suitable elevation where the arched spring strip 12 imparts a pressure to the shutter 20 to hold down the shutter 20 accurately in vertical, and then nails, screws, or proper fastening members are driven through the hanging strip 21 of the shutter 20 into the wall 22 to fixedly secure the shutter 20 to the wall 22.

FIG. 3 shows an alternate form of the present invention. According to this embodiment, the shutter mounting adjuster is provided between one vertical peripheral wall 32 of an opening for shutter and the hanging strip 31 of a shutter 30, comprising two sliders 41 and 42 movably mounted in the longitudinal sliding groove of the hanging strip 31 of the shutter 30, and an arched spring strip 43 fixedly mounted on the sliders 41 and 42. The arched spring strip 43 has an arched body portion 431 pressed on the wall 32, and two mounting tips 432 respectively extended from the two distal ends of the arched body portion 431 in reversed directions and respectively fixedly fastened to the sliders 41 and 42.

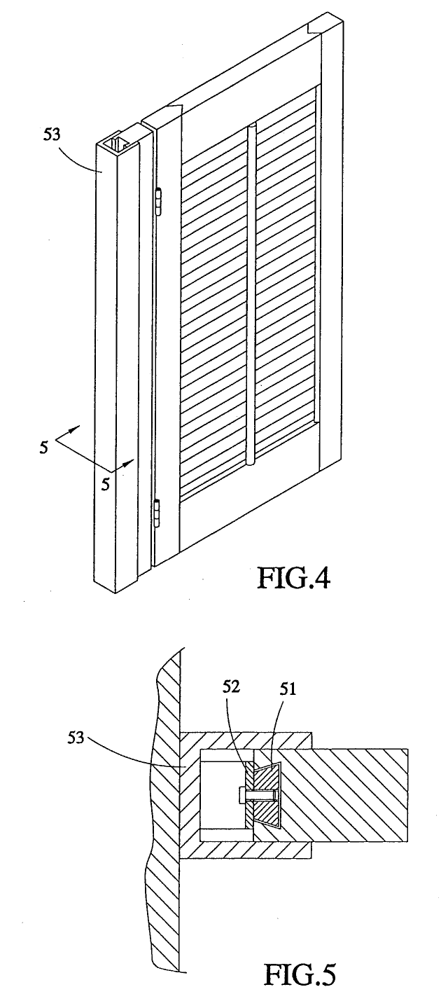

FIGS. 4 and 5 show another alternate form of the present invention. According to this embodiment, the shutter mounting adjuster further comprises an ornamental cover strip 53 shaped like a channel bar having a U-shaped cross section and adapted to protect the slider 51 and the spring strip 52 against external bodies and to enhance the sense of beauty of the shutter.

A prototype of shutter mounting adjuster has been constructed with the features of FIGS. 2˜5. The shutter mounting adjuster functions smoothly to provide all of the features discussed earlier.

Although particular embodiments of the invention have been described in detail for purposes of illustration, various modifications and enhancements may be made without departing from the spirit and scope of the invention. For example, any of a variety of other shapes and forms of spring members may be used instead of the aforesaid arched spring strip. Accordingly, the invention is not to be limited except as by the appended claims.

What is claimed is:

1. A shutter mounting adjuster provided between one vertical peripheral wall of an opening for shutter and a hanging strip of a shutter to support said shutter in vertical, the hanging strip of said shutter having a longitudinal sliding groove facing said vertical peripheral wall, the shutter mounting adjuster comprising:
at least one slider mounted in the longitudinal sliding groove of the hanging strip of said shutter and movable along said longitudinal sliding grove, and
a spring member fixedly mounted on said at least one slider for movement with said at least one slider along the longitudinal sliding groove of the hanging strip of said shutter, said spring member having at least one portion thereof pressed on said vertical peripheral wall.

2. The shutter mounting adjuster as claimed in claim 1, wherein said spring member is an arched spring strip.

3. The shutter mounting adjuster as claimed in claim 1, further comprising an ornamental cover strip adapted to protect said at least one slider and said spring member.

4. The shutter mounting adjuster as claimed in claim 3, wherein said ornamental cover strip is shaped like a channel bar having a U-shaped cross section.

5. A shutter mounting adjuster provided between one vertical peripheral wall of an opening for shutter and a hanging strip of a shutter to support said shutter in vertical, the hanging strip of said shutter having a longitudinal sliding groove facing said vertical peripheral wall, the shutter mounting adjuster comprising:
a slider mounted in the longitudinal sliding groove of the hanging strip of said shutter and movable along said longitudinal sliding groove, and
an arched spring strip fixedly mounted on said slider for movement with said slider along said longitudinal sliding groove, said arched spring strip having an arched body portion fixedly fastened to said slider and two bearing tips respectively pressed on said vertical peripheral wall.

6. The shutter mounting adjuster as claimed in claim 5, further comprising an ornamental cover strip adapted to protect said slider and said spring strip.

7. The shutter mounting adjuster as claimed in claim 6, wherein said ornamental cover strip is shaped like a channel bar having a U-shaped cross section.

8. A shutter mounting adjuster provided between one vertical peripheral wall of an opening for shutter and a hanging strip of a shutter to support said shutter in vertical, the hanging strip of said shutter having a longitudinal sliding groove facing said vertical peripheral wall, the shutter mounting adjuster comprising:
two sliders respectively mounted in the longitudinal sliding groove of the hanging strip of said shutter and movable along said longitudinal sliding groove, and
an arched spring strip fixedly mounted on said sliders for movement with said sliders along said longitudinal sliding groove, said arched spring strip having an arched body portion pressed on said vertical peripheral wall and two mounting tips respectively fixedly fastened to said sliders.

9. The shutter mounting adjuster as claimed in claim 8, further comprising an ornamental cover strip adapted to protect said sliders and said spring strip.

10. The shutter mounting adjuster as claimed in claim 9, wherein said ornamental cover strip is shaped like a channel bar having a U-shaped cross section.
